(19) United States
(12) Patent Application Publication
(10) Pub. No.: US 2013/0126288 A1
(43) Pub. Date: May 23, 2013

(54) BEAD-CHAIN DRIVING CLUCH FOR SUPER-HEAVY-DUTY ROLLER BLIND WITH SELF-LOCKING COIL SRPING SYSTEM DRIVEN PRIOR TO PLANETARY GEAR DECELERATOR

(71) Applicant: Yongzhong Qiu, Guangzhou (CN)

(72) Inventor: Yongzhong Qiu, Guangzhou (CN)

(21) Appl. No.: 13/392,522

(22) PCT Filed: Jul. 6, 2011
(86) PCT No.: PCT/CN2011/076923

§ 371 Date: Feb. 25, 2012

(30) Foreign Application Priority Data
Aug. 6, 2010 (CN) 201020284837.0

(51) Int. Cl. F16D 13/12

(52) U.S. Cl. CPC F16D 13/12
USPC 192/20

(57) ABSTRACT

The invention releases a BEAD-CHAIN DRIVING CLUCH FOR SUPER-HEAVY-DUTY ROLLER BLIND WITH SELF-LOCKING COIL SPRING SYSTEM DRIVEN PRIOR TO PLANETARY GEAR DECELERATOR which comprises the following components in order: Cluch base, sprocket wheel, rotating arm, self-locking coil spring system, planetary gear decelerator, traveling limit device. The mechanism of the invention is as follow: unscrew the bolt from the Cluch base and attach the chain guide apparatus to opening A or opening B on the base to achieve from-the-top installation; to opening C or opening D to achieve lateral installation thus achieving flexibility and extending applicability to meet the need of different location and positioning to install, be it from the top, from the left or right. The invention places the self-locking coil spring system prior to the planetary gear decelerator, reduces pre-tension by leveraging the force from the blind through the planetary gear decelerator before transferring the force to the spring, thus the effort needed to pull the chain is reduced.

### FIELD OF THE INVENTION

The invention relates to a roller blind Cluch, more specifically to a Cluch for super-heavy-duty roller blind with self-locking coil spring system driven prior to planetary gear decelerator.

### BACKGROUND OF THE INVENTION

Nowadays, chain driving roller blind is widely used in commercial buildings, restaurants, offices and residences as a shading device. Roller blind can be subcategorized into motorized roller blind and manual chain driving roller blind. Chain driving roller blind is more widely used than others due to its simple structure and low cost.

The common manual bead-chain driving roller blind mainly consists of the following components: male mount bracket, female mount bracket, clutch, end plug, bead-chain and the roller tube for hanging a blind. Self-locking coil spring system is commonly built in the Cluch and planetary gear decelerator is built-in in some cases, an assembly of which achieves easy and labor-saving maneuverability of a roller blind.

The bead-chain is installed into the sprocket wheel in the Cluch. Rolling of the blind is achieved by pulling the bead-chain which drives the sprocket wheel, the wheel then drives the roller tube to rotate.

The regular built-in and self-locking coil spring system is fitted in the side of the Cluch near the male mount bracket while the planetary gear decelerator is fitted in the side of the Cluch near the female mount bracket, in which design of the torque from the sprocket wheel first drives the planetary gear decelerator, then drives the self-locking coil spring system, and then drives the roller tube. This design necessitates the self-locking spring's bearing constant pre-tension from the total weight of the blind. In case of load bearing of 20 KGS, thicker and higher-strength or more springs are prerequisite and the chain need to be pulled harder.

Traveling limit device inside the Cluch that available on the existing market is operated by a limiting component built in a fixed position which can only achieve one way limit of the blind.

### SUMMARY OF THE INVENTION

The first object of the invention is to reverse the positioning used by old design of the planetary gear decelerator and the self-locking coil spring system, placing the self-locking coil spring system inside the planetary gear decelerator. In the invention, pulling pressure is balanced by the planetary gear decelerator before being transferred to the self-locking coil spring system. The torque on the spring equals to the weight of the load bearing multiplied by the reduction ratio. With this mechanism, the pre-tension on the spring is reduced, so that the structure is capable of bearing larger load.

The second object of the invention is to achieve flexibility and extended applicability to meet the need of different location and positioning to install. The design uses a simple mechanism to actualize installation from the top, left or right which is as follow: unscrew the bolt from the Cluch base and attach the chain guide apparatus to opening A or opening B on the base to achieve from-the-top installation; to opening C or opening D to achieve lateral installation.

The third object of the invention is to provide a traveling limit device which consists of a limit screw threaded by a limit nut and a traveling nut. The traveling nut is mortised inside the roller tube to follow the tube's movement. The traveling nut rotates along the thread between the cap of the limit screw and the limit nut, restricting the traveling nut's movement range hence restricting the roller tube's revolution range hence the blind's movement range, preventing the blind tube from over-rotating and thus achieving both upper and lower movement limit of the blind.

### BRIEF DESCRIPTION OF THE DRAWINGS

Embodiments of the invention are described in detail with figures.

FIG. 1 shows an exploded perspective view of the invention and the assembly diagram of the travelling limit device.

FIG. 2 shows an exploded perspective view of the planetary gear decelerator;

FIG. 3 shows an exploded perspective view of the self-locking coil spring system;

FIG. 4 shows an exploded perspective view of the structure of the invention;

FIG. 5 shows a half-sectional view of the invention;

FIG. 6 shows the core shaft;

FIG. 7 shows Opening A in the Cluch base in the BEAD-CHAIN guide apparatus;

FIG. 8 shows Opening B in the Cluch base for the BEAD-CHAIN guide apparatus;

FIG. 9 shows Opening C in the Cluch base for the the BEAD-CHAIN guide apparatus;

FIG. 10 shows Opening D in the Cluch base for the the BEAD-CHAIN guide apparatus.

### DETAILED DESCRIPTION OF THE INVENTION

The components of the invention include: Cluch base; sprocket wheel, which is hollowed with a tenon in the center and built-in near the side of the end plug; rotating arm, whose front projected arm is mortised in and driven by the sprocket wheel. Self-locking coil spring system circles the rotating arm with an inward folded arm attached to one end of the rotating arm by which the spring is strained (locking area) and another inward-folded arm attached to the other end of the rotating arm by which the spring is released (unlocking area). The planetary gear decelerator, which encircles the self-locking coil spring system, is mortised in the Cluch base by tenons, the said unlocking area of the coil spring being attached to the projected arm of the sun gear of the planetary gear decelerator and the planetary gear being driven prior to the said spring; core shaft, which is the core passing through the rotating arm, the self-locking coil spring system and the planetary gear decelerator with one end mortised on the tenon of the sprocket wheel and fixed on the Cluch base. The bushing which encircles is coupled with the planetary gear decelerator.

As one example of the preferred embodiment, the Cluch base consists of three components, the base body, the bead chain guide apparatus and the mount bracket. The base body is a rectangular, one side of it is fastened to the mount bracket, the other three sides are of four openings (A, B, C, D) for the bead-chain guide apparatus. The design uses a simple mechanism to actualize flexible installation as needed as follow: unscrew the bolt from the Cluch base and attach the chain guide apparatus to opening A or opening B on the base to achieve from-the-top installation; to opening C or opening D to achieve lateral installation.

As one example of the preferred embodiment, the traveling limit device consists of the following components: the limit screw, the traveling nut and the limit nut. The limit screw is attached to the rear end of the core shaft.

As a preferred embodiment for the invention, a tenon, located on the center of joint surface of sprocket wheel and Cluch base, joins the mortise on core shaft head to fix the core shaft on the Cluch base.

As one preferred embodiment for the invention, the said planetary gear decelerator comprises: the main frame, of which, the side near the Cluch base is attached to the sprocket wheel, and whose internal teeth join the gears inside, and which places the sprocket wheel between the said planetary gear decelerator and the Cluch base, sun gear of the planetary gear system, which is coaxial with the main frame and whose projected teeth meshes the locking area of the self-locking coil spring system; bracket, which is coaxial with the sun gear; planet gears, which meshes the internal teeth of the main frame and the sun gear.

As one preferred embodiment for the invention, four planetary gears are distributed in the mainframe.

As one preferred embodiment for the invention, the planetary gear decelerator is covered with an endcap to hold fast all gears and the axis.

As one preferred embodiment for the invention, reduction ratio of the planetary gear decelerator is 1:4 or else.

As one preferred embodiment for the invention, the self-locking coil spring system apparatus comprises a spring case, a coil spring which has two inward folded arms to divide the spring into a locking area and an unlocking area and is encased in the spring case, and the projected arm of the sun gear attached to the locking area while the projected part of the rotating arm is attached to the unlocking area to rotate.

As one preferred embodiment for the invention, in the gap between the sprocket wheel, rotating arm, the Cluch bushing and the travelling and limit system, front ball bearing and rear ball bearing are to be installed.

As one preferred embodiment for the invention, the front ball bearing and rear ball bearing are deep-groove-ball bearings.

As one preferred embodiment for the invention, the limit screw of the traveling limit device can be left-handed or right-handed threaded.

### The Advantages of the Invention

1. The invention reverses the positioning of the self-locking coil spring system and the planetary gear decelerator, placing the self-locking coil spring system inside the planetary gear decelerator. The load of blind and other pedants first act on the planetary gear decelerator which drives the self-locking coil spring system, the force on the spring being equal to the load of the blind multiplied by the reduction ratio. By this mechanism, the invention is capable of enduring SUPER-HEAVY-DUTY with steady and easy maneuverability and is widely used in beaded-chain roller blind especially those with SUPER-HEAVY-DUTY.

2. Unscrew the bolt from the Cluch base and attach the chain guide apparatus to opening A or opening B on the base to achieve from-the-top installation; to opening C or opening D to achieve lateral installation. By this mechanism, the invention achieves flexibility and extended applicability to meet the need of different location and positioning to install, be it from-the-top or lateral installation.

3. The invention also provides a traveling limit device which consists of a limit screw threaded by a limit nut and a traveling nut. The traveling nut is mortised inside the roller tube to follow the tube's movement. The traveling nut rotates along the thread between the cap of the limit screw and the limit nut, restricting the traveling nut's movement range hence restricting the roller tube's revolution range hence the blind's movement range, preventing the blind tube from over-rotating and thus achieving both upper and lower movement limit of the blind.

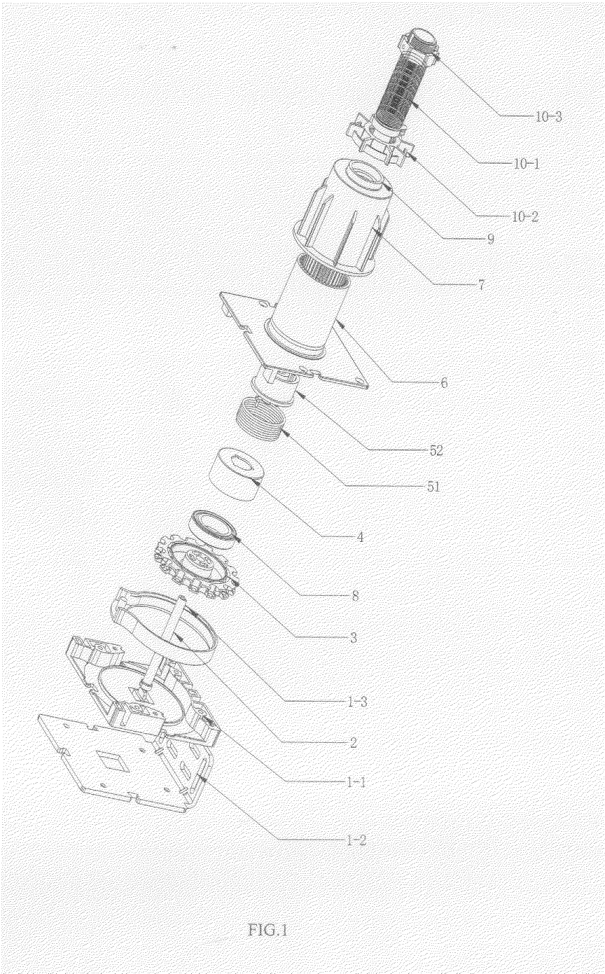

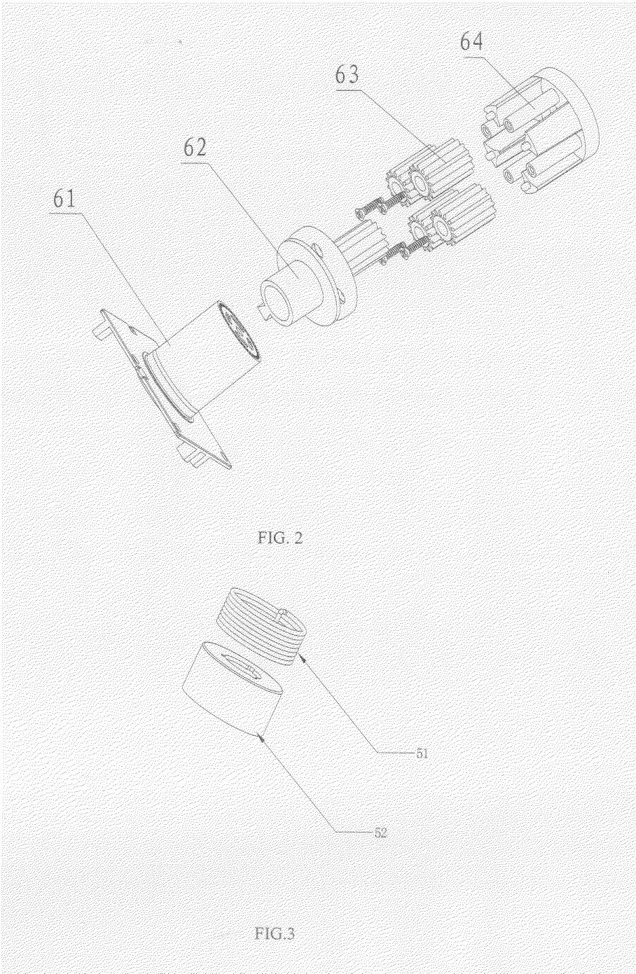

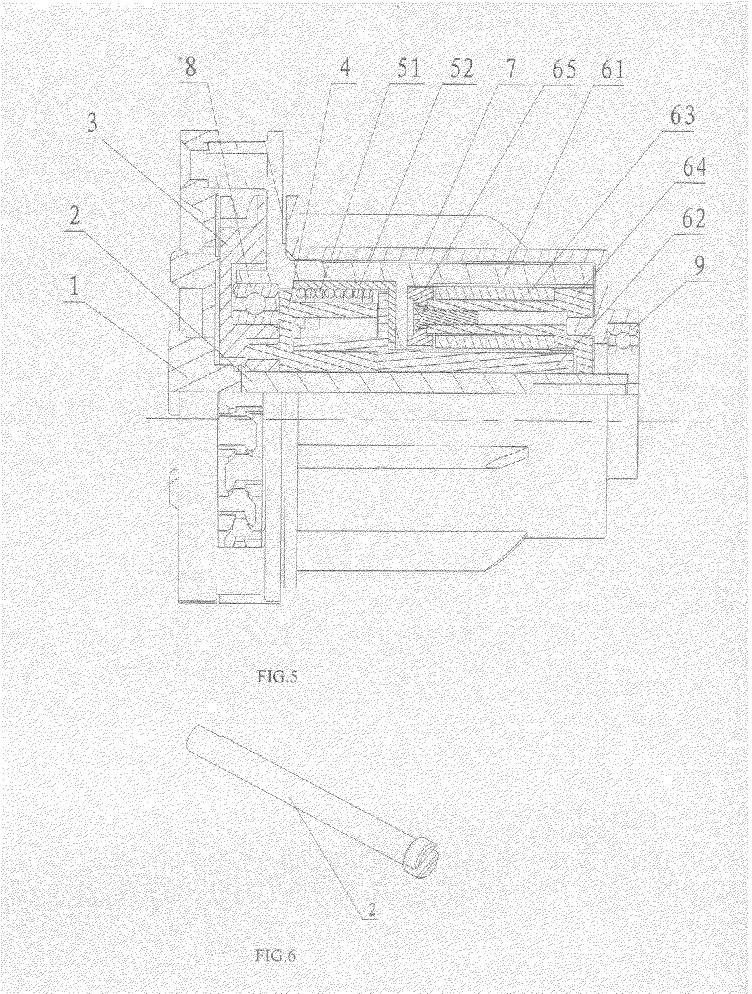

With reference to the FIG. 1 to FIG. 9, a bead-chain driving Cluch for SUPER-HEAVY-DUTY roller blind with self-locking coil spring system driven prior to planetary gear decelerator comprises:

Cluch base (1), core shaft (2), sprocket wheel (3), rotating arm (4), self-locking coil spring system (5), planetary gear decelerator (6), and travelling limit device (10).

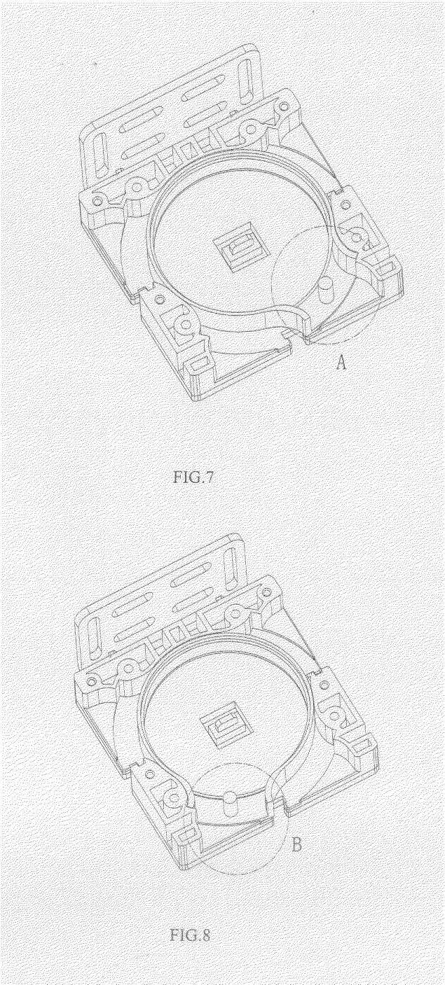

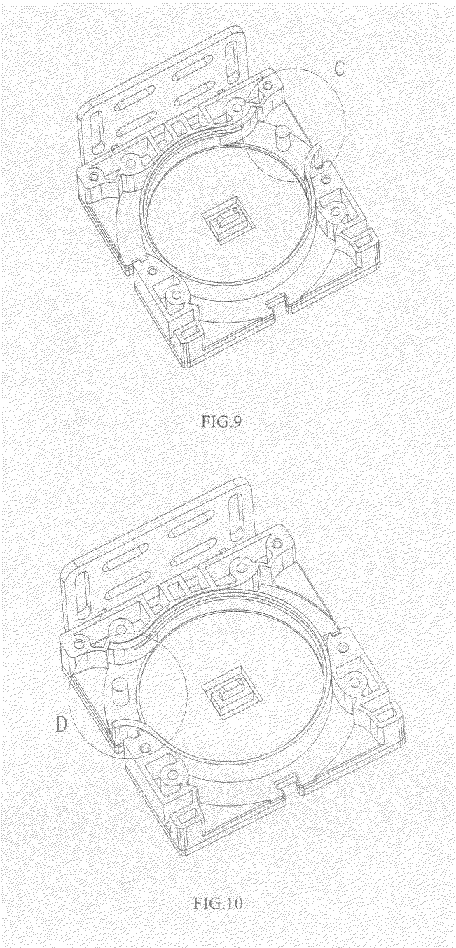

Cluch base (1) comprises: Cluch body (1-1), chain guide apparatus (1-2) and mount bracket (1-3). Cluch body (1-1) is a rectangle with one side fixed by the male mount bracket (1-3). Unscrew the bolt from the Cluch base (1-1) and attach the chain guide apparatus (1-2) to opening A (FIG. 7) or opening B (FIG. 8) on the base to achieve from-the-top installation; to opening C (FIG. 9) or opening D (FIG. 10) to achieve lateral installation. By this mechanism, the invention achieves flexibility and extended applicability to meet the need of different location and positioning to install, be it from-the-top or lateral installation.

Sprocket wheel (3), which is hollowed with a tenon in the center.

Rotating arm (4), with a front projected arm and a rear projected arm along the axis of the rotating arm (4), the said front projected arm being attached to and synchronized with the sprocket wheel (3).

The self-locking coil spring system (5), with its inside divided into a locking area and an unlocking area, encircles the rotating arm (4) whose rear projected arm can insert into the said unlocking area to rotate.

The planetary gear decelerator (6) encircles the self-locking coil spring system (5), which is placed between the Cluch base and the planetary gear decelerator. The mainframe of the planetary gear decelerator is fixed in the Cluch base (1), and the projected arm of the sun gear is attached to the locking area of the self-locking coil spring system (5).

The planetary gear decelerator comprises:

Mainframe (61), whose inner wall is toothed to mesh with planet gears, and whose side near the end plug is screwed with the sprocket wheel (3) and the Cluch body (1-1) of the Cluch (1), placing the sprocket wheel (3) between the mainframe (61) and the Cluch base (1);

Sun gear (62), which is coaxial with the mainframe (61), a projected part of which is attached to the locking area of the self-locking coil spring system (5);

The planetary gear bracket (64), which encircles and is coaxial with the sun gear (62); four planet gears with a reduction ratio of 1:4 (63), which are distributed evenly in the planetary gear brackets (64) and meshed with the internal teeth of the mainframe (61) and the sun gear (62) and which are hold fast by an end cap (65);

Core shaft (2) which is in the center and whose one end has a mortise on one end to join the tenon in the Cluch base (1) and whose other end passes through the rotating arm (4), the self-locking coil spring system (5) and the planetary gear decelerator (6).

The traveling limit device (10), whose limit screw (10-1) is right-handed or left-handed threaded and is connected with the other end of the core shaft (2). Two other components of the traveling limit device are the limit nut (10-3) and the traveling nut (10-2) which encircles the limit screw (10-1). The traveling nut (10-2) is mortised inside the roller tube to follow the tube's movement. The traveling nut (10-2) rotates along the thread between the cap of the limit screw (10-1) and the limit nut (10-2), restricting the traveling nut's movement range hence restricting the roller tube's revolution range hence the blind's movement range, preventing the blind tube from over-rotating and thus achieving both upper and lower movement limit of the blind.

FIGS. 3, 4 and 5, further describe a preferred embodiment. The said self-locking coil spring system (5) consists of coil spring case (52), the coil spring, which encased in the coil spring case (52), with two inward folded arms dividing the self-locking coil spring system (5) into a locking area and an unlocking area. The projected part of the sun gear of the planetary gear decelerator (6) is attached to the locking area and the projected part of the rotating arm is attached to the unlocking area. The blind tube used to hang the blind encircles and drives the bushing (7) which then drives the sun gear (62) whose projected arm is attached to the locking area of the spring (51) which cushions the torque therein and maintain balance, achieving self-locking. When torque from the sprocket (3) drives the rotating arm (4) which drives the sun gear (62), the spring (51) doesn't resist, hence drives the tube. This invention reverses the positioning of the planetary gear decelerator and the self-locking coil spring system, so the load from the blind drives the planetary gear decelerator (6) which then drives the self-locking coil spring system (5), reducing the pre-tension on the spring (51), the force on the spring be equal to the load multiplied by the reduction ratio. By his mechanism, the invention is capable of bearing super-heavy-duty with steady and easy maneuverability which makes it widely used for super-heavy-duty roller blind.

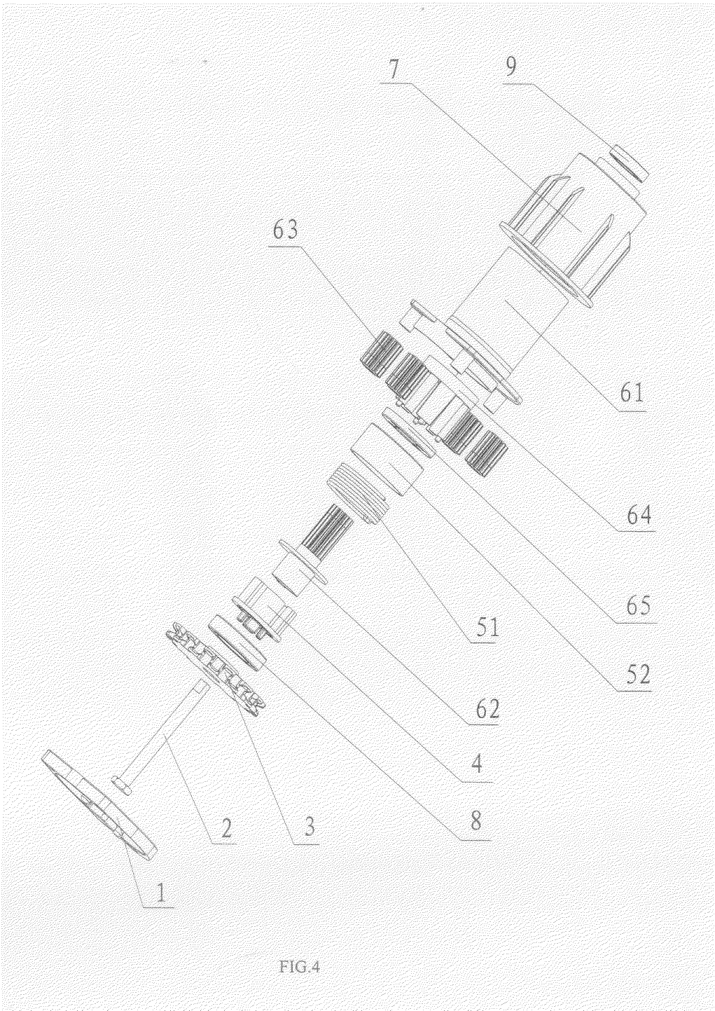

FIGS. 4 and 5 further describe a preferred embodiment.

In the gap between the said sprocket wheel, rotating arm and the bushing front ball bearing (8) and rear ball bearing (9) which are deep groove ball bearings are to be installed to stabilize and reduce rotating abrasion.

The above are preferred embodiments which are not meant to be inflexible. Technician with corresponding expertise is free to make slight changes according to the above embodiment, which will be considered equivalent embodiment and is under the scope of this invention.

What is claimed is:

1. A Cluch for super-heavy-duty roller blind with self-locking coil spring system driven prior to planetary gear decelerator comprising:
a Cluch base (1);
sprocket wheel (3) grooved in its center with holes and disposed close to the end plug near the side of said Cluch base (1);
rotating arm (4) consisting of forwardly projecting arm and backwardly projecting arm along its longitudinal center line; said forwardly projecting arm is connected with said sprocket wheel (3) and rotates with it;
the self-locking coil spring system (5), with its inside divided into a locking area and an unlocking area, encircling said rotating arm (4) with its side wall tenon inserted into said unlocking area and rotating;
the planetary gear decelerator (6) encircling in said self-locking coil spring system (5), with the end near the Cluch base (1) as its front. With the self-locking coil spring system (5) cradled in said front of the planetary gear decelerator (6), its external ring gears are connected with the Cluch base (1). At the center of the planetary gear decelerator (6), there is sun gear with tenon fitted into the locking area of the self-locking coil spring system (5);
the core shaft (2) encircled in the center with its end connected with said Cluch base (1); This end of said core shaft (2) is locked to groove of said sprocket wheel (3) and rotates; the distal end of said core shaft (2) threads through said groove of sprocket wheel (3), rotating arm (4), self-locking coil spring system (5) and planetary gear decelerator (6);
bushing (7) encircling planetary gear decelerator (6) and interlocked with the output end of the planetary gear decelerator (6).

2. A Cluch for super-heavy-duty roller blind with self-locking coil spring system driven prior to planetary gear decelerator according to claim 1, wherein said Cluch base (1) consists of square Cluch body (1-1), chain guide apparatus (2) and, mount bracket (1-3); said Cluch body (1), with openings (A, B, C, D) for fastening chain guide apparatus( 1-2), is connected with the mount bracket (1-3) by means of screws; said chain guide apparatus (1-2) can be fixed at any of the openings.

3. A Cluch for super-heavy-duty roller blind with self-locking coil spring system driven prior to planetary gear decelerator according to claim 1, wherein said Cluch body (1-1) is fixed with planetary gear decelerator (6) by means of screws;
In case of from-the-top installation, loosen the screw fastening the planetary gear decelerator (6) and the Cluch body (1-1), then adjust the chain guide apparatus (1-2) to the direction of opening A or B; in case of lateral installation, loosen the screw fastening the planetary gear decelerator (6) and the Cluch body (1-1), then adjust the chain guide apparatus (1-2) to the direction of opening C or D.

4. A Cluch for super-heavy-duty roller blind with self-locking coil spring system driven prior to planetary gear decelerator according to claim 1 comprising travelling limit device (10) including limit screw (10-1), traveling nut (10-2) and limit nut (10-3), with limit screw (10-1) connected with the tail of said core shaft (2).

5. A Cluch for super-heavy-duty roller blind with self-locking coil spring system driven prior to planetary gear decelerator according to claim 1, wherein said planetary gear decelerator (6) includes:
the planetary gear decelerator body (61), with its inner wall engaging into planetary gear, its side near the end plug matched with the sprocket wheel (3) and interlinked with the Cluch (1) to make sprocket wheel (3) between the Cluch (1) and planetary gear decelerator body part (61);
centre gear (62), the sun gear of the planetary gear system, located on the concentric axis with the planetary gear decelerator body (61), possessing near the rotating arm (4), a fan-shaped tenon which is stuffed in the locking area of the self-locking coil spring system (5);
Planetary gear bracket (64), encircling the outside of center gear (62) and rotated on concentric axis with center gear;
planetary gear (63), fitted on said planetary gear bracket (64), engaging with the inner gear of the planetary gear decelerator body (61) and center gear (62);
said self-locking coil spring system (5) consisting of:
coil spring base (52);
coil spring (51), cradled in the coil spring base (52), with its head and tail winding to form a supporting arm which divides the inner space of self-locking coil spring system (5) into locking area and unlocking area so that the tenon of said sun gear in said planetary gear decelerator (6) will be locked in said locking area of coil spring base (52) and the backwardly projecting arm of said rotating arm (4) can be plugged into the unlocking area to rotate.

6. A Cluch for super-heavy-duty roller blind with self-locking coil spring system driven prior to planetary gear decelerator according to claim 1, wherein said core shaft (2) possesses a grooved end; said Cluch base (1) and sprocket wheel (3) has on the center of their joint surface a tenon plugged into said grooved end of said core shaft (2) so that said core shaft (2) can be fitted with said Cluch base (1).

7. A Cluch for super-heavy-duty roller blind with self-locking coil spring system driven prior to planetary gear decelerator according to claim 1, wherein said planetary gear( 63) of which the number is four, are placed evenly on the planetary gear bracket (64).

8. A Cluch for super-heavy-duty roller blind with self-locking coil spring system driven prior to planetary gear decelerator according to claim 1, wherein said planetary gear decelerator (6) is matched with end cap (65); said end cap (65) is fitted to planetary gear bracket (63) so that it can fasten the planetary gears (63) by covering them.

9. A Cluch for super-heavy-duty roller blind with self-locking coil spring system driven prior to planetary gear decelerator according to claim 1, wherein said planetary gear decelerator (6) has a reduction ratio of 1:4.

10. A Cluch for super-heavy-duty roller blind with self-locking coil spring system driven prior to planetary gear decelerator according to claim 1, wherein front ball bearing (8) and rear ball bearing (9) are installed respectively in the gap between said sprocket wheel (3) and rotating arm (4) as well as between the bushing (7) and travelling limit device (10).
